(19) United States
(12) Patent Application Publication
(10) Pub. No.: US 2007/0184852 A1
(43) Pub. Date: Aug. 9, 2007

(54) Method and system for location of objects within a specified geographic area

(76) Inventors: David W. Johnson, Escondido, CA (US); Thomas A. La Rovere, Santa Barbara, CA (US); Larry Weaver, Santa Barbara, CA (US); Bruce W. Bivans, Goleta, CA (US)

Correspondence Address: MORRISON & FOERSTER LLP, 12531 HIGH BLUFF DRIVE, SUITE 100, SAN DIEGO, CA, 92130-2040, US

(21) Appl. No.: 11/652,779

(22) Filed: Jan. 12, 2007

Related U.S. Application Data
(60) Provisional application No. 60/759,774, filed on Jan. 17, 2006.

(51) Int. Cl. H04Q 7/20

(52) U.S. Cl. 455/456.1

(57) ABSTRACT

A method and system for determining the location of objects within a geographic area is disclosed. In one embodiment, the system includes a plurality of portable transceiver devices each coupled to a respective object located within the geographic area; a plurality of stationary transceiver devices fixed at predetermined locations within the geographic area, wherein the plurality of stationary transceiver devices are each configured to determine received signal strength (RSSI) values of signals transmitted by the plurality of portable transceiver devices; and a base station, comprising a base station transceiver device and a computer coupled to the base station transceiver device, wherein the base station is configured to receive RSSI values from at least one of the plurality of stationary transceiver devices and calculate a location of at least one portable transceiver device based on the received RSSI values.

### RELATED APPLICATIONS

This application claims priority under 35 U.S.C. § 119(e) to U.S. Provisional Application Ser. No. 60/759,774, entitled “Process Methods and Apparatus for Autolocation of Specific Vehicles of Interest Within a Parking Area,” filed on Jan. 17, 2006, the entirety of which is incorporated by reference herein.

### FIELD OF THE INVENTION

The invention relates generally to locating objects using radio frequency (RF) signals and more particularly, to a method and system for utilizing received signal strength indications (RSSI) to calculate and identify the location of objects within a specified geographic area.

### BACKGROUND OF THE INVENTION

Current methods used by operators of parking areas such as car lots, service stations and fleet operations involve periodic manual inventory procedures and tracking systems based on key pegs, bar coded stock stickers and numbered parking places. These manually based systems create significant problems for parking lot operators since vehicles are often moved around to different parking spaces as well as being removed or introduced to the parking lot. In facilities utilizing these manual systems, it is often difficult and time-consuming to locate a particular vehicle of interest which results in wasted time and human resources.

Existing wireless location techniques are relatively inaccurate and not well-suited for determining the precise location of an object. For example, WiFi based location techniques that utilize RSSI levels are based on data packet broadcasts, which are inconsistent from one broadcast to the next since the data transmitted is different from one broadcast to the next. Additionally, traditional WiFi communication protocols are optimized for data communication, not providing accurate location services. As another example, existing mesh communication networks that utilize RSSI levels are not optimized for determining the location of objects. These networks utilize RSSI levels to validate signal strength levels for data communication purposes—not to determine precise locations of objects (e.g., cell phones). For example, traditional Wifi and cell phone applications cannot accurately determine the location of objects because they are limited by their signal strength measurement resolution (e.g., limited to 128 bits). This coarse signal strength measurement may be adequate for determining the strength of a communication channel for data communication purposes, or determining the location of objects at a very coarse level (e.g., within a relatively large area or zone). These systems, however, are not designed to provide precise location information. Furthermore, in these prior systems, the transmitted data packets are inconsistent between communication sessions and transmitted power output and receiver sensitivity are not calibrated for ranging accuracy.

### SUMMARY OF THE INVENTION

The invention addresses the above and other needs by providing a new method and system for automatically locating objects within a specified geographic area by utilizing a plurality of portable transceiver devices (referred to herein as “Vmotes”) and a plurality of stationary wireless nodes (e.g., beacons) that communicate with the plurality of Vmotes. At least one of the beacons communicates with a base station wireless node coupled to a computer. The beacons transmit received signal strength indication (RSSI) values for signals transmitted by one or more of the Vmotes to the base station and a computer then calculates the location of a Vmote of interest within a specified geographic area based on the RSSI values.

In one embodiment, the invention is utilized to provide a simple, rapid and cost effective means to locate a specific vehicle within a specified geographic area (e.g., parking lot or inventory lot). This system requires relatively minimal equipment installation and may be used on either a permanent or temporary basis. In one embodiment, portable Vmotes are placed in or on each vehicle located in the parking lot (e.g., a commercial parking garage or car dealership). The portable Vmotes are battery-powered transceiver devices that further include processing circuitry and a memory. In one embodiment, each Vmote is capable of receiving signals from other Vmotes and beacons and calculating RSSI values of the received signals. Thus, after the location of a Vmote is determined each Vmote is itself capable of temporarily functioning as a “soft beacon” and providing measured RSSI values to one or more designated beacons or the base station. This ability to dynamically add “soft beacons” improves accuracy of the system by providing additional data points while minimizing the number of beacons required for the system. As used herein, a “soft beacon” refers to a portable transceiver device coupled to a moveable object within a geographic area that can temporarily function as a stationary beacon after its location has been determined.

In one embodiment, no beacons are necessary in the system. A plurality of otherwise portable Vmotes are fixed at calibrated locations within the geographic area and function as beacons. The fixed Vmotes may be battery-powered, solar powered and/or coupled to external power sources. The fixed Vmotes may communicate wirelessly to the base station node or communicate via a dedicated network interface that is connected to the base station node. The portable Vmotes placed in or on each vehicle can communicate with other portable Vmotes as well as with the fixed Vmotes to form a mesh communication network. In one embodiment, RSSI values for signals transmitted and received by a particular Vmote are utilized to calculate the location of that Vmote. In a further embodiment, RSSI values of signals transmitted between portable Vmotes are utilized in addition to the RSSI values of signals transmitted between portable and stationary Vmotes to calculate the location of a particular portable Vmote in the mesh network. As used herein, the term “portable” means that a device is not designed or intended to be fixed at a single location within a specified geographic area.

In a further embodiment, one or more Vmotes and optionally one or more beacons forming a wireless mesh network utilize multiple ranging signals transmitted at various frequencies, various power levels, and/or modulated with different modulation parameters (e.g., amplitude, frequency, phase, etc.) to reduce the effects of multipath interference. In one embodiment, a stationary Vmote or a beacon transmits a plurality of reference signals utilizing various predetermined frequencies, power levels and/or modulation parameters. These multiple transmissions reduce multipath effects which are known to distort RSSI values and enhance location calculation accuracy by providing additional data points (e.g., frequency, transmission power, RSSI values) for the location calculation (e.g., triangulation) algorithm.

In another embodiment, the invention provides a display that identifies the location of a specific vehicle within a parking lot graphically illustrating its position rather than only a location identifier such as parking space number. This provides an advantage for operators who may utilize paved or unpaved areas which do not have delineated or identified parking spaces.

### BRIEF DESCRIPTION OF THE DRAWINGS

FIG. 1 illustrates a parking lot having a communication network to rapidly and accurately identify the location of vehicles, in accordance with one embodiment of the invention.

FIG. 2 is a block diagram of a mesh communication network having a plurality of Vmotes and beacons, in accordance with one embodiment of the invention.

FIG. 3 is a block diagram of an exemplary Vmote, in accordance with one embodiment of the invention.

FIG. 4 is a block diagram of an exemplary beacon, in accordance with one embodiment of the invention.

FIG. 5 is a block diagram of an exemplary base station, in accordance with one embodiment of the invention.

FIG. 6 is a functional diagram of the operation of a Vmote, in accordance with one embodiment of the invention.

FIG. 7 is a functional diagram of the operation of a beacon, in accordance with one embodiment of the invention.

FIG. 8 is a flowchart of activities performed by the base station and user interaction with the system, in accordance with one embodiment of the invention.

FIG. 9 illustrates a procedure for entering a new vehicle into the system, in accordance with one embodiment of the invention.

FIG. 10 is a functional diagram of a procedure for removing vehicles from the system, in accordance with one embodiment of the invention.

### DETAILED DESCRIPTION OF THE PREFERRED EMBODIMENT

In the following description of exemplary embodiments, reference is made to the accompanying drawings which form a part hereof, and in which it is shown by way of illustration specific embodiments in which the invention may be practiced. It is to be understood that other embodiments may be utilized and structural changes may be made without departing from the scope of the present invention.

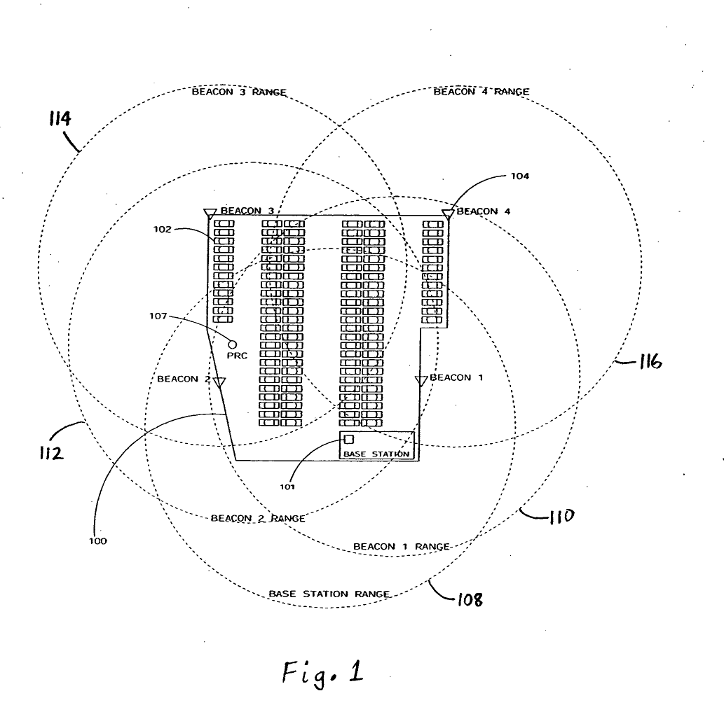

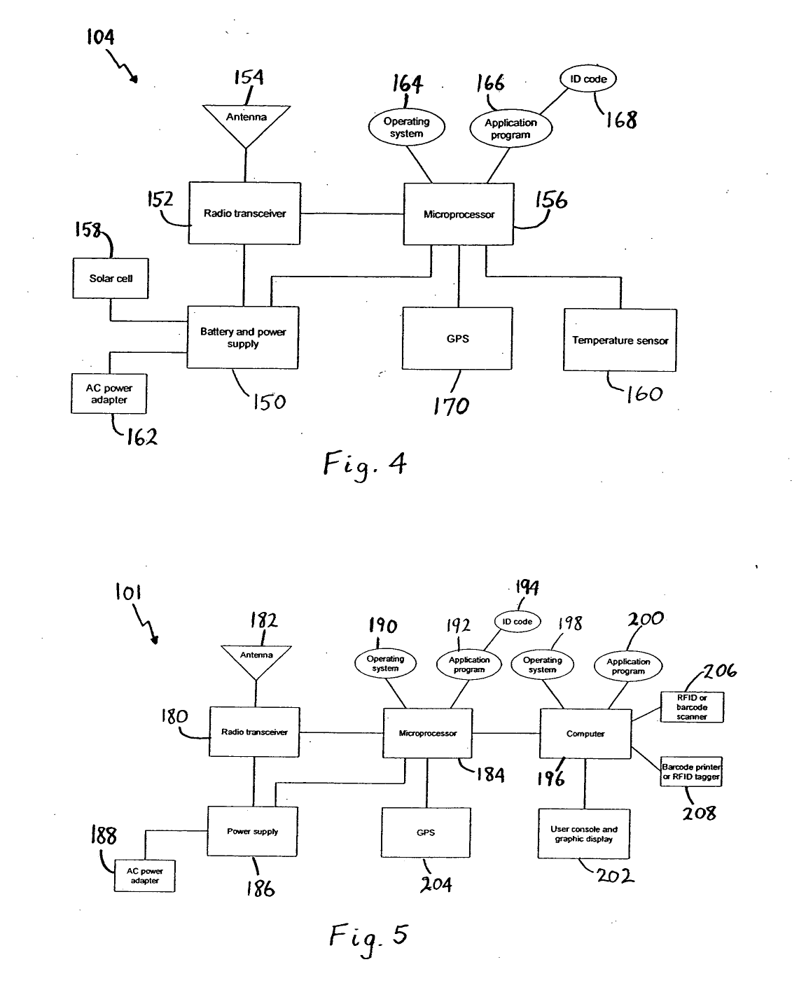

FIG. 1 illustrates a typical parking lot area 100 of arbitrary shape and dimensions wherein a mesh communication network is established to rapidly and accurately identify the location of vehicles, in accordance with one embodiment of the invention. The mesh network includes a base station 101 at an arbitrary location within the lot area 100, a plurality of vehicles 102 each equipped with a portable transceiver device (not shown) attached to or contained within each vehicle 102, and a plurality of stationary communication nodes or beacons 104 positioned at relative locations across the lot area 100 so as to provide satisfactory radio communication over the area 100. The portable transceiver devices associated with each vehicle are referred to herein as Vmotes and described in further detail below with reference to FIG. 3, in accordance with one embodiment of the invention. The architecture and functionality of the beacons 104 are also described in further detail below with reference to FIG. 4, in accordance with one embodiment of the invention.

In a further embodiment, the vehicle location finding system of the invention includes a personal remote console (PRC) 107 which may be positioned at any arbitrary location within the lot 100 or, alternatively, allowed to roam or have its position changed within the lot at any time. The PRC 107 provides a portable and remote user interface for users to enter information and receive information pertaining to the location of vehicles. In one embodiment, the PRC 107 communicates wirelessly with the base station to retrieve desired information. In a further embodiment, the PRC 107 provides a portable remote graphical user interface that communicates with the base station directly or via the mesh network.

As illustrated in FIG. 1, the base station 101 and each beacon 104 has a wireless communication range indicated by respective dashed-lines forming a circular radius around the base station 101 and each respective beacon 104. The base station 101 has a communication range indicated by circular radius 108. A first beacon 104 (designated as Beacon 1) has a communication range indicated by circular radius 110. A second beacon 104 (designated as Beacon 2) has a communication range indicated by circular radius 112. A third beacon 104 (designated as Beacon 3) has a communication range indicated by circular radius 114. A fourth beacon 104 (designated as Beacon 4) has a communication range indicated by circular radius 116. As shown in FIG. 1, Beacons 1 and 2 are within communication range of the base station 101. However, Beacons 3 and 4 are not within communication range of the base station 101. Therefore, in one embodiment, in order for Beacons 3 and 4 to communicate wirelessly with the base station 101, they must do so via Beacons 1 or 2 or via one or more of the Vmotes located in or on a vehicle 102.

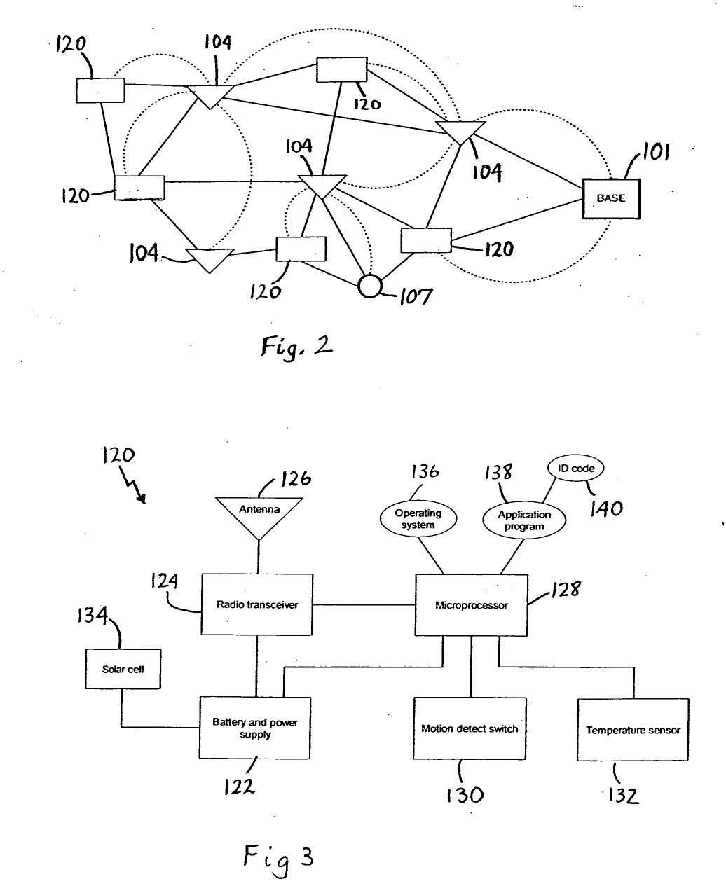

FIG. 2 is a block diagram of a mesh communication network having a plurality of Vmotes 120 and beacons 104 within and without radio range of each other, in accordance with one embodiment of the invention. As illustrated in FIG. 2, the solid lines 122 between two devices indicate ranging signals transmitted between the two devices. At each Vmote 120 or beacon 104 the RSSI value can be measured for a received ranging signal. The dashed line 124 between two devices indicates that the two devices are within communication range and a communication link may be established between the two devices.

In one embodiment, each Vmote 120 communicates directly with the base station or beacons for data communication and to transmit and receive radio ranging signals. This embodiment utilizes a direct radio communication in order to reduce Vmote network activity in order to minimize Vmote battery consumption. As mentioned above, however, Vmotes 124 are capable however to be used as location references the same as beacons 104 once their locations are defined. Thus, after the location of a particular Vmote 124 has been determined, it may function as a “soft beacon” and receive ranging signals from other Vmotes 124 and measure the RSSI of the received signals. These measured RSSI values are then transmitted to the base station 101 and used to calculate the location of the other Vmotes 124.

The number of “soft beacons” in the mesh network may be dynamically increased as desired to increase location estimation algorithm accuracy and extend the potential range of the wireless location system and network. The accuracy is improved because more RSSI values or data points are provided to the location estimation algorithm executed by the base station computer. The range is increased because, each Vmote 120 that turns into a “soft beacon” can receive signals from another Vmote 120 that may not be within range of a dedicated fixed beacon 104. The ability of Vmotes 120 to enter into a “soft beacon” mode is useful to minimize the number of beacons that need to be deployed within a parking lot area, and hence reduce hardware and installation costs. One drawback of Vmotes 120 operating in a “soft beacon” mode, however, is the reduction of battery life of the extra-utilized Vmotes 120. In one embodiment, the beacons 104 may be replaced with Vmotes 120 that are fixed at calibrated locations. In this embodiment, the fixed Vmotes 120 take over the functionality of the beacons 104. Thus, the necessity of purchasing and installing the beacons 104 is eliminated.

FIG. 3 is a block diagram of an exemplary Vmote 120, in accordance with one embodiment of the invention. In this embodiment, the Vmote 120 includes a battery or power supply 122, a radio transceiver 124, antenna 126 and a microprocessor or controller 128. In further embodiments, the Vmote 120 may optionally include a motion detection switch 130, a temperature sensor 132 and/or a solar power cell 134. In one embodiment, the microprocessor 128 executes an operating system 136 and application program 138 stored in a memory (not shown). In alternative embodiments, some or all of the functionality of the microprocessor 129 may be implemented via programmable logic circuits and/or an application specific integrated circuit (ASIC). Each Vmote 120 is programmed with a unique identification code 140, which is also stored in the memory, for network addressing. In one embodiment, this ID code 140 is transmitted with ranging signals sent by each Vmote 120.

In one embodiment, a Vmote 120 is designed to operate with limited battery power over extended periods of time and therefore it is programmed to be in sleep mode most of the time and only awaken for operation when triggered by its motion switch or a specific radio command (e.g., wake up signal) from an external device (e.g., another Vmote, beacon, or base station). In one embodiment, the wake up signal includes the unique ID code 140 of a particular Vmote 120, which will not wake up unless its ID code matches the ID code in the wake-up signal. In one embodiment, each Vmote 120 is capable of measuring the signal strength of radio transmissions from beacons 104, other Vmotes 120 and/or the base station 101. In addition to receiving ranging signals and monitoring ranging data (e.g., RSSI levels), Vmotes 120 can also monitor and report back to the base station 101, either directly or via another Vmote 120 or a beacon 104, the status of its motion switch 130, temperature sensor 130 and/or battery 122.

FIG. 4 is a block diagram of an exemplary beacon 104, in accordance with one embodiment of the invention. In this embodiment, the beacon 104 contains a battery 150, radio transceiver 152, antenna 154, and a microprocessor controller 156. In a further embodiment, the beacon may also include a solar power cell 158, a temperature sensor 160 and an AC adapter 162 to receive power from a utility power line (not shown). In one embodiment, the microprocessor 156 incorporates an operating system 164 and application program 166 stored in a memory (not shown). In alternative embodiments, some or all of the functionality of the microprocessor 156 may be implemented via programmable logic circuits and/or an application specific integrated circuit (ASIC). Each beacon 104 is further programmed with a unique identification code 168 for network addressing. Each beacon 104 can measure the signal strength of radio transmissions from a plurality of Vmotes 120 and the base station 101. In one embodiment, in addition to the ranging data, beacons 104 can also monitor and report back to the base station 101 its temperature and battery condition, or that of Vmotes 120 that communicate through the beacons 120. In one embodiment, a beacon 104 may also incorporate a GPS receiver 170 to provide GPS reference location data to automatically calibrate reference locations and map them onto the lot area 100. The location of Vmotes 120 may then be calculated with respect to these reference locations.

FIG. 5 is a block diagram of an exemplary base station 101, in accordance with one embodiment of the invention. The base station 101 includes a radio transceiver 180, antenna 182, a microprocessor/controller 184, a power supply 186 and an AC adapter 188 for receiving utility power. In one embodiment, the microprocessor 184 executes an operating system 190 and application program 192 stored in a memory (not shown) coupled to the microprocessor 184. In alternative embodiments, some or all of the functionality of the microprocessor 192 may be implemented via programmable logic circuits and/or an application specific integrated circuit (ASIC). Each base station 101 measures the signal strength of radio transmissions from Vmotes 120 and the beacons 104. The base station microprocessor 184 is further programmed with a unique identification code 194 for network addressing. In one embodiment, the base station microprocessor 184 communicates with a computer 196 via a serial interface. However, in alternative embodiments the microprocessor 184 can communicate with the computer 196 via wireless connection or via a computer network connection (e.g., modem).

In one embodiment, the computer 194 executes an operation system 198 and application program 200 stored in a computer memory (e.g., hard drive). The computer 194 is used to perform the necessary calculations to determine Vmote locations based on radio signal strength data received from the Vmotes 120 and beacons 104. A user or operator console 202 including a graphic display is also driven by the computer 194. In one embodiment, the base station 101 may also incorporate a GPS receiver 204 to provide reference location data that may be used to automatically calibrate reference locations corresponding to beacon and/or Vmote locations in the lot area 101. In one embodiment, if the base station 101 is located inside a building or under a building structure, an externally located GPS antenna having direct line of site visibility to a GPS satellite can be coupled to the GPS receiver 204.

In a further embodiment, the base station 101 may include a RFID or barcode scanner 206 for reading identification information for each vehicle 102 that enters or leaves the lot area 100. In this way, the inventory of vehicles 102 entering or leaving the lot 100 may be automatically tracked and updated. This vehicle identification information (e.g., VIN) can then be used to correlate other information or objects with the vehicle. For instance, in one embodiment a barcode printer or RFID tagger 208 may further be included for generating a barcode label or a RFID tag containing the VIN of a particular vehicle. The barcode label or RFID tag may then be affixed or attached to a set of keys associated with the particular vehicle. After a Vmote 120 is attached to the vehicle and deployed in the lot 100, the vehicle may be subsequently located by retrieving its keys and passing the barcode label or RFID tag through the reader 206. Upon reading the VIN of the vehicle from the bar code label, for example, the computer 196 will determine its corresponding Vmote 120 unique ID code 140 and determine the location of the Vmote 120 as described herein.

In one embodiment, Vmotes 120 are physically attached to vehicles 102 as said vehicles enter into a parking lot area 100. In one embodiment, the Vmote 120 is attached to the roof of the vehicle 102 via a magnet located on the housing of the Vmote 120. Before a Vmote 120 is attached to the vehicle 102, the unique Vmote identification code 140 along with the vehicle identification number (VIN) are entered into the base station computer 196 by means of manual keyboard entry, bar code scanner and/or RFID reader 206. The base station computer 196 thereby establishes a data record which associates a specific Vmote 120 with a specific vehicle 104. Additionally, as discussed above, a bar code label or radio frequency identification tag is automatically created which is then attached to the vehicle keys. Thereafter, the keys are stored in a location where it may easily be identified and retrieved.

In a further embodiment, the RFID reader 206 is portable and may be utilized to interrogate a plurality of RFID tags attached to a plurality of keys stored in a storage area. The VIN of a desired vehicle, for example, is entered into the portable RFID reader, which then generates and transmits an interrogation signal containing this VIN, or other code, to the plurality of key RFID tags. Upon receiving the interrogation signal from the reader, each RFID tag determines if the received VIN matches the VIN stored in the RFID tag memory. If it does not match, the interrogation signal is ignored. If there is a match, an optional light or audio alarm on the key RFID tag is activated by logic circuitry within the RFID tag. In this way, keys belonging to a particular vehicle may easily be located and retrieved from a key storage area.

After a vehicle 102 with an attached Vmote 120 is parked within the lot area 100 the Vmote 120 communicates with the one or more beacons 104 and/or other Vmotes 120 and the base station 101. Vmote communication may be initiated by an integrated motion switch or by a specific radio command (e.g., wake-up command) issued from the base station either directly or via an intermediate beacon 104 or Vmote 120 operating in “soft beacon” mode. Radio signals received by each respective Vmote 120, beacon 104 and the base station 101 are quantitatively measured as radio signal strength associated with the transmitting device. These radio signal strength values are then compared to calibrated field strength data that was previously correlated with corresponding locations within the lot area 100 to determine the current location of the Vmote 120.

After a vehicle 102 is parked, the user may scan the identification tag attached to the vehicle keys in order to initiate the system to locate the specified vehicle and update the vehicle data record. In one embodiment, this procedure may be conveniently performed at the base station console 202. The keys are then conveniently stored. In a further embodiment, the computer 196 can be used to measure the time taken to park the car and ensure the keys are scanned in and stored to ensure procedural compliance and efficiency.

In one embodiment, the location of a specific vehicle or a listing of all vehicles within the parking lot area may be determined at any time by initiating a user command at the console 202. The location record of each vehicle is also automatically updated whenever a Vmote 120 is moved as detected by its motion sensor or switch 130.

In order to conserve battery power and maximize battery lifespan, Vmotes 120 are normally in a sleep mode and can be awakened by an integrated motion switch or by a specific radio command received from an external source (e.g., base station 101, beacon 104 or another Vmote 120). Also, since Vmote battery power is limited and radio range is thereby restricted, Vmotes 120 may or may not be within direct range of the base station and therefore conveniently utilize a mesh networking protocol to transfer data through strategically placed beacons 104 or other Vmotes 120. In order to simplify the network protocol, radio transmissions from beacons 104 or Vmotes 120 operating in “soft beacon” mode are controlled by commands from the base station. In one embodiment, all Vmotes 120 and beacons 104 may be within direct communication range with the base station 101.

In one embodiment, distance between a transmitter and receiver is directly determined based on the measured received radio signal strength relative to the transmitted signal power. Radio transmissions from a Vmote 120 can be received by other Vmotes 120, beacons 104 and/or directly by the base station 101. Each Vmote 120 or beacon 101 reports received signal strength values to the base station 101. In one embodiment, the base station computer 196 receives at least three RSSI values pertaining to a particular Vmote 120 and performs a triangulation calculation to determine the location of the Vmote 120 based on the signal strength of the received signals relative to the time synchronized power levels of the transmitted output. All necessary information for performing these synchronized measurements and calculations is provided by the transmitted ranging signals.

In one embodiment, the location of Vmotes 120 may be determined using a method whereby parking locations are pre-calibrated with a set of associated received radio signal strength (RSSI) values thus creating a data map of the parking area. Accuracy of the calculated position improves as the number of radio frequency channels and number of beacons is increased. Practical location accuracy for a typical application is in the order of a few feet. In one embodiment, the location of Vmotes 120 can be determined through three dimensions and suitable for multistory parking structures as well as flat lots.

In one embodiment, in order to further improve the accuracy of the location calculations, the invention utilizes mesh network technology which effectively allows each Vmote 120 to talk to other Vmotes 120, as well as to beacons 104 and the base station 101. In one embodiment, the beacons 104 may be implemented by utilizing Vmote devices fixed at calibrated known locations within the lot 100 (e.g., at the locations where a beacon 104 would be placed as indicated in FIG. 1). Preferably, the fixed Vmote beacons 104 are placed at a higher elevation (e.g., on a light pole) to improve line of site transmission to the plurality of remote, moveable Vmotes 120 attached to the vehicles 102 in the lot 100. It will be appreciated that in this embodiment, there is no need to purchase and install separate and distinct beacon devices, which is advantageous from a manufacturing, installation and cost perspective.

In one embodiment, the invention utilizes RSSI levels received by a plurality of beacons 104 from one or more ranging signals transmitted by a particular Vmote 120 of interest. Via known triangulation methods these RSSI levels are used to calculate a location of the Vmote 120. In a further embodiment, location calculation accuracy is enhanced by further utilizing RSSI levels received by the Vmote from one or more beacons 104, thereby providing additional data points for the calculation. Additionally, once a position estimate is derived for a particular vehicle's Vmote, in one embodiment, that Vmote can be utilized as a temporary “soft beacon” to estimate the position of other Vmotes 120 in the lot 100. By adding additional “soft beacons” as desired the communication range of the location finding mesh network may be dynamically increased. Furthermore, by adding soft beacons to the network more data points may be provided to the base station 101 to improve the accuracy of the triangulation or location determining calculations. As will be appreciated, the ability to utilize a single transceiver device as both portable location tags attached to vehicles as well as stationary beacons provides significant cost advantages over prior art hardwired LAN based WiFi systems. Additionally, the ability to add “soft beacons” and utilize RSSI levels both transmitted and received by a Vmote significantly improves the accuracy of the location calculations.

In one embodiment, in order to further enhance accuracy and reliability of location calculations, multiple ranging signals are transmitted between a Vmote 120 and beacon 104 at multiple different frequencies and/or multiple modulation schemes to reduce the effects of multipath interference that would otherwise adversely effect RSSI measurements. For example, in one embodiment, a first ranging signal is transmitted from a Vmote 120 to a beacon 104 (or vice versa) at a first frequency and/or modulated with a first set of modulation parameters, a second ranging signal is sent at a second frequency and/or modulated with second set of modulation parameters, and a third ranging signal is sent at a third frequency and/or modulated with a third set of modulation parameters. By varying the transmission frequencies and modulation parameters, the effects of multipath interference can be significantly reduced. In one embodiment, the beacon 104 calculates an average RSSI value of the RSSI values for each ranging signal. In an alternative embodiment, the beacon 104 may select the median RSSI value. In another embodiment, the beacon 104 may ignore the lowest RSSI value and take the average of the remaining two. Or the beacon 104 may implement a combination of these algorithms or other algorithms that would be apparent to those skilled in the art.

Thus, the present invention can significantly improve the accuracy of location calculations by transmitting multiple ranging signals modulated a specific set of frequencies and modulation parameters in order to reduce the effect of multipath interference, which is known to distort the RSSI measurements. In one embodiment, these multiple transmissions at predetermined frequencies and power levels enhance triangulation accuracy by providing additional frequency vs. power vs. RSSI data points for the triangulation algorithm.

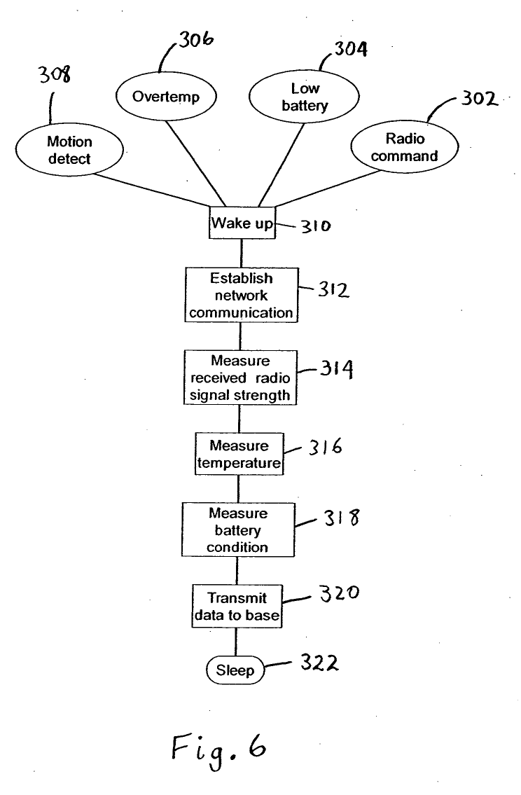

FIG. 6 is a functional diagram of the operation of a Vmote 120, in accordance with one embodiment of the invention. In this embodiment, the Vmote 120 remains in sleep mode most of the time using minimal battery power and only wakes up from sleep mode upon receiving a wake up radio command 302, or a signal or condition indicating low battery level 304, an over-temperature condition 306, or motion switch detection 308. Upon the occurrence of any of these conditions, at step 310, the Vmote 120 will wake up from sleep mode and the Vmote microprocessor 128 begins to execute its application program 138. At step 312, the Vmote 120 establishes a network communication link with at least one other device (e.g., beacon 104 or base station 101) and, in one embodiment, transmits one or more ranging signals to the other device. At step 314, the Vmote 120 measures received radio signal strength of a signal transmitted by the other device. At step 316, the Vmote 120 measures or retrieves a temperature reading from its temperature sensor. At step 318, the Vmote 120 measures its battery condition. At step 320, the Vmote 120 transmits one or more, or all, of the data values collected in the above steps to the base station 101. At step 322, the Vmote 120 returns to sleep mode.

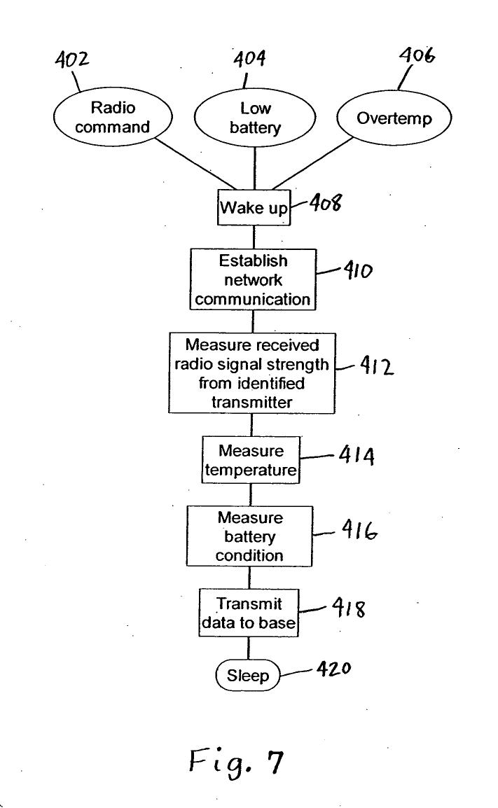

FIG. 7 is a functional diagram of the operation of a beacon 104, in accordance with one embodiment of the invention. In one embodiment, the beacon 104 remains in sleep mode most of the time using minimal battery power and only wakes up reception of a radio command 402 (e.g., from a Vmote or base station), or a condition indicating a low battery level 404, or an over-temperature condition 406. Upon receiving a signal indicating one of these conditions, the beacon 104 will wake up from sleep mode at step 408. At step 410, the beacon 104 establishes communications with one or more Vmotes 120 and, in one embodiment, transmits one or more ranging signals to the Vmote 120. At step 412, the beacon 104 measures received radio signal strength of a signal transmitted by the Vmote 120. At step 414, the beacon 104 measures or retrieves a temperature reading from its temperature sensor 160. At step 416, the beacon 104 measures its battery condition. At step 418, the beacon 104 transmits one or more, or all, of the data values collected in the above steps to the base station 101. At step 420, the beacon 104 returns to sleep mode.

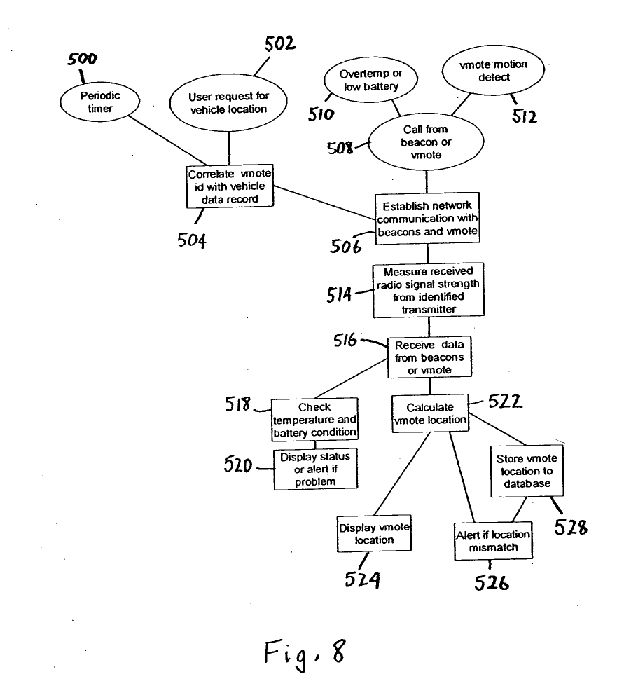

FIG. 8 is a flowchart of activities performed by the base station 101 and user interaction with the system, in accordance with one embodiment of the invention. If, at step 500, a signal is received from a periodic timer, or alternatively, if a user request for a vehicle location is received at step 502, the base station computer is programmed to correlate Vmote ID's with vehicle data records at step 504 to update the system records and/or determine the location of a desired vehicle. If a user has requested a vehicle location, at step 506, the base station establishes communications with Vmotes and beacons in the network. The base station will establish network communications with Vmotes and/or beacons if a signal call is received from a beacon or Vmote (step 508) due to an overtemp or battery low condition (510) or a Vmote motion detection condition (512).

After establishing network communications, at step 514, the base station 101 will measure received radio signal strength from an identified transmitting device. At step 516, it then receives data (e.g., temp, battery, RSSI values) from beacons and/or Vmotes. At step 518, the base station checks temperature and battery conditions of network devices based on the received data. At step 520, the base station will display a status of the network devices and/or generate an alert if there is a problem with one or more of the devices. At step 522, the base station 101 calculates at least one Vmote location based on the received RSSI data. At step 524, an alert is generated if there is a mismatch between the calculated location and a location stored in its database. At step 526, the newly calculated location is stored in the base station database.

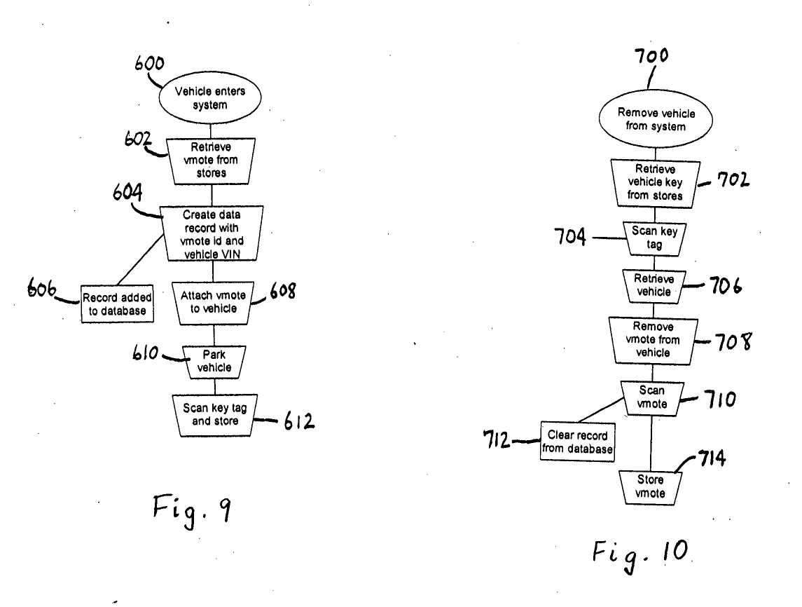

FIG. 9 illustrates a procedure for entering a new vehicle into the system, in accordance with one embodiment of the invention. At step 600, a new vehicle 102 enters the lot 100. At step 602, an employee of the lot retrieves a Vmote from storage. At step 604, using the base station computer, the employee creates a data record containing the Vmote ID and the vehicle VIN. At step 606, the data record is added to the database. At step 608, the Vmote is attached to the vehicle. In one preferred embodiment, the Vmote is attached to the roof the vehicle via a magnet coupled to the housing of the Vmote. At step 610, the employee parks the newly entered vehicle. At step 612, the keys of the vehicle are scanned into the system to verify completion of the process and stored.

FIG. 10 is a functional diagram of a procedure for removing vehicles from the system when they are leaving the lot 100, for example. At step 700, a decision has been made to remove the vehicle from the system. At step 702, the keys for the vehicle are retrieved from storage. At step 704, the RFID tag or bar code label attached to the key are scanned and the base station computer generates a display indicating the location of the vehicle on the lot. At step 706, the vehicle is retrieved. At step 708, the Vmote attached to the vehicle is removed. At step 710, the removed Vmote is scanned and its corresponding record in the database is cleared at step 712. Finally, at step 714, the Vmote is stored and, if necessary, its battery is recharged.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but can be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system for determining the location of objects within a geographic area, comprising:
a plurality of portable transceiver devices each coupled to a respective object located within the geographic area, wherein at least one of the portable transceiver devices is configured to determine a received signal strength (RSSI) value of a signal transmitted by another portable transceiver device;
a plurality of stationary transceiver devices fixed at predetermined locations within the geographic area, wherein the plurality of stationary transceiver devices are each configured to determine received signal strength (RSSI) values of signals transmitted by the plurality of portable transceiver devices; and
a base station, comprising a base station transceiver device and a computer coupled to the base station transceiver device, wherein the base station is configured to receive RSSI values from at least one of the plurality of stationary transceiver devices and calculate a location of at least one portable transceiver device based on the received RSSI values.

2. The system of claim 1 wherein the plurality of portable transceiver devices can communicate indirectly with the base station by utilizing a mesh network communication protocol that relays communication messages through one or more other portable transceiver devices or stationary transceiver devices.

3. The system of claim 2 wherein at least one of the plurality of portable transceiver devices can further communicate directly with the base station.

4. The system of claim 1 wherein after the location of one of the plurality of portable transceiver devices has been determined by the base station, the portable transceiver device whose location has been determined is configured to temporarily function as a new stationary transceiver device.

5. The system of claim 1 further comprising a display coupled to the computer for displaying a graphic representation of the calculated location of the at least one portable transceiver device within a graphic representation of the geographic area.

6. The system of claim 1 further comprising a bar code scanner coupled to the computer.

7. The system of claim 1 further comprising a radio frequency identification tag (RFID) reader coupled to the computer.

8. The system of claim 1 wherein each of the plurality of portable transceiver devices is powered by a battery and solar cell.

9. The system of claim 8 wherein each of the stationary transceiver devices are powered by a battery and a solar cell.

10. The system of claim 1 wherein each of the plurality of portable transceiver devices further includes a motion detector device.

11. The system of claim 1 wherein each of the plurality of portable transceiver devices are configured to be in sleep mode until awakened by the occurrence of one or more predetermined conditions.

12. The system of claim 1 wherein each of the portable transceiver devices are configured to transmit a plurality of signals at different frequencies in order to reduce multipath interference effects.

13. The system of claim 1 wherein each of the portable transceiver devices are configured to transmit a plurality of signals at different power levels in order to reduce multipath interference effects.

14. The system of claim 1 wherein each of the portable transceiver devices are configured to transmit a plurality of signals modulated with different modulation parameters in order to reduce multipath interference effects.

15. The system of claim 1 wherein each of the stationary transceiver devices are configured to transmit a plurality of signals at different frequencies in order to reduce multipath interference effects.

16. The system of claim 1 wherein each of the stationary transceiver devices are configured to transmit a plurality of signals at different power levels in order to reduce multipath interference effects.

17. The system of claim 1 wherein each of the stationary transceiver devices are configured to transmit a plurality of signals modulated with different modulation parameters in order to reduce multipath interference effects.

18. The system of claim 1 wherein the objects each comprise a motor vehicle and the geographic area comprises a parking lot area.

19. The system of claim 18 wherein each of the plurality of portable transceiver devices are attached to an exterior surface of a respective vehicle.

20. The system of claim 19 wherein the plurality of portable transceiver devices are attached to the exterior surface of respective vehicles via magnetic means.

21. A system for determining the location of objects within a geographic area, comprising:
a plurality of portable transceiver devices each coupled to a respective object located within the geographic area and configured to transmit a plurality of signals having different transmission characteristics so as to reduce multipath interference effects;
a plurality of stationary transceiver devices fixed at predetermined locations within the geographic area and configured to receive the plurality of signals from respective ones of the plurality of portable transceiver devices, wherein the plurality of stationary transceiver devices are each configured to determine received signal strength (RSSI) values of the plurality of signals transmitted by respective ones of the plurality of portable transceiver devices; and
a base station, comprising a base station transceiver device and a computer coupled to the base station transceiver device, wherein the base station is configured to receive the RSSI values from at least one of the plurality of stationary transceiver devices and calculate a location of at least one portable transceiver device based on the received RSSI values.

22. The system of claim 21 wherein the different transmission characteristics comprise different transmission frequencies.

23. The system of claim 21 wherein the different transmission characteristics comprise different transmission power levels.

24. The system of claim 21 wherein the different transmission characteristics comprise different modulation parameters used to modulate the plurality of signals.

25. The system of claim 21 wherein at least one of the portable transceiver devices is configured to determine a received signal strength (RSSI) value of a signal transmitted by another portable transceiver device.

26. The system of claim 25 wherein after the location of one of the plurality of portable transceiver devices has been determined by the base station, the portable transceiver device whose location has been determined is configured to function as a new stationary transceiver device.

27. The system of claim 21 wherein the plurality of portable transceiver devices can communicate indirectly with the base station by utilizing a mesh network communication protocol that relays communication messages through one or more other portable transceiver devices or stationary transceiver devices.

28. The system of claim 21 wherein at least one of the plurality of portable transceiver devices can further communicate directly with the base station.

29. The system of claim 21 further comprising a display coupled to the computer for displaying a graphic representation of the calculated location of the at least one portable transceiver device within a graphic representation of the geographic area.

30. The system of claim 21 further comprising a bar code scanner coupled to the computer.

31. The system of claim 21 further comprising a radio frequency identification tag (RFID) reader coupled to the computer.

32. The system of claim 21 wherein each of the plurality of portable transceiver devices is powered by a battery and solar cell.

33. The system of claim 32 wherein each of the stationary transceiver devices are powered by a battery and a solar cell.

34. The system of claim 21 wherein each of the plurality of portable transceiver devices further includes a motion detector device.

35. The system of claim 21 wherein each of the plurality of portable transceiver devices are configured to be in sleep mode until awakened by the occurrence of one or more predetermined conditions.

36. The system of claim 35 wherein the predetermined conditions comprise motion detection, a low battery condition, a temperature condition, or receipt of an external wake up signals.

37. The system of claim 21 wherein the objects each comprise a motor vehicle and the geographic area comprises a parking lot area.

38. The system of claim 37 wherein each of the plurality of portable transceiver devices are attached to a surface of a respective vehicle.

39. The system of claim 38 wherein the plurality of portable transceiver devices are attached to an exterior surface of respective vehicles via magnetic means.
